(19) United States
(12) Patent Application Publication
(10) Pub. No.: US 2018/0283581 A1
(43) Pub. Date: Oct. 4, 2018

(54) Interlocking Axial Pipe Fitting Squares

(71) Applicant: Jose Ramirez, West Jordan, UT (US)

(72) Inventor: Jose Ramirez, West Jordan, UT (US)

(21) Appl. No.: 15/934,843

(22) Filed: Mar. 23, 2018

Related U.S. Application Data
(60) Provisional application No. 62/475,401, filed on Mar. 23, 2017.

(51) Int. Cl. F16L 1/06; G01B 3/00

(52) U.S. Cl. CPC F16L 1/06; G01B 3/002

(57) ABSTRACT

A disclosed pipe fitting device for squaring and fitting pipe comprises at least two members, one or more of which is a straight edge member and one or more of which is a square edge member. An axis is configured to interlock the two members in a variable angular and square configuration. A protractor as disclosed is in axial relation with the interlocking axis and configured to provide an angular measure of the relation of the two members. Additionally, the axis comprises a bottom slider and a top slider configured to slide in a trough of a member and therefore provide a variable axis placement for the joining of the two members. Each member defines an offset trough configured a length thereof to receive a component of the axis including the sliders. The protractor comprises a radial crenellation configured to interlock the members in the angular and square relation.

### CROSS REFERENCE TO RELATED APPLICATION

This application claims the benefit of the priority date of earlier filed U.S. Provisional Patent Application Ser. No. 62/475,401 filed Mar. 23, 2017 by Jose Ramirez, and is incorporated herein by reference in its entirety.

### BACKGROUND OF THE INVENTION

Conventional tools available to a pipe fitter are two dimensional and therefore present problems to three dimensional pipe fitting. For instance, a conventional “L” shaped square may slide off the crest of a pipe where it is put by a fitter during squaring of a fitting to a section of pipe and render a squaring in accurate. Furthermore, the pipe fitter may not even be aware that his square has slide off the pipe crest and rendered his fitting inaccurate.

A small degree of offset in any of three dimensions in a pipe fitting weld can put a destination end of the pipe inches and even feet off a desired target. For this reason alone it is crucial that a pipefitter get as close as possible to a straight weld, an orthogonal weld and an angular weld according to specifications. However, a pipe fitter has limited tools at his disposal to fit and weld a pipe to straight, square and angular specifications.

### SUMMARY OF THE INVENTION

A disclosed pipe fitting device for squaring, trimming and fitting pipe comprises at least two pipe fitting members, one or more of which is a straight edge member and one or more of which is a square edge member. An axis is configured to interlock the two members in a variable angular and a variable square configuration. A protractor as disclosed is in axial relation with the interlocking axis and configured to provide an angular measure of the relation of the two members. A system of magnifier lenses is also disposed at the axis and at least one end of the members. Magnets are also received in an outside edge of at least one member for providing a bond between the pipe fitting squaring device and the pipe fittings that aids a user in the squaring process. Additionally, the axis comprises a bottom slider and a top slider configured to slide in a trough of a member and therefore provide a variable axis placement for the joining of the two members. Each member defines an offset trough configured a length thereof to receive a component of the axis including the sliders. The protractor comprises a radial crenellation configured to interlock the members in the angular and square relation. The protractor also defines at least one chamfered hole configured to lock it in place relative to a member.

Other aspects and advantages of embodiments of the disclosure will become apparent from the following detailed description, taken in conjunction with the accompanying drawings, illustrated by way of example of the principles of the disclosure herein.

### BRIEF DESCRIPTION OF THE DRAWINGS

FIG. 1 is a depiction of two interlocking pipe fitting squares configured to square a ninety degree elbow in accordance with an embodiment of the present disclosure.

FIG. 2 is a depiction of two interlocking pipe fitting squares configured to square a pipe flange in accordance with an embodiment of the present disclosure.

FIG. 3 is a depiction of two interlocking pipe fitting squares configured to square a forty five degree elbow in accordance with an embodiment of the present disclosure.

FIG. 4 is a depiction of two interlocking pipe fitting squares configured to square a thirty degree elbow in accordance with an embodiment of the present disclosure.

FIG. 5 is a depiction of two interlocking pipe fitting squares configured to square a fifteen degree elbow in accordance with an embodiment of the present disclosure.

FIG. 6 is a depiction of two interlocking pipe fitting squares configured to square an eccentric reducer in accordance with an embodiment of the present disclosure.

FIG. 7 is a perspective view of interlocking pipe fitting straight edges comprising a protractor hinge in accordance with an embodiment of the present disclosure.

FIG. 8 is a perspective view of interlocking pipe fitting squares comprising a protractor hinge in accordance with an embodiment of the present disclosure.

FIG. 9 is a split elevational view and side elevational view of an indexed hinge protractor in accordance with an embodiment of the present disclosure.

FIG. 10 is a perspective view of a top slider for the interlocking pipe fitting squares in accordance with an embodiment of the present disclosure.

FIG. 11 is a top view of interlocking pipe fitting straight edges comprising an indexed protractor hinge with magnifying lenses in accordance with an embodiment of the present disclosure.

FIG. 12 is a perspective view of a thumb screw for the interlocking protractor hinge in accordance with an embodiment of the present disclosure.

FIG. 13 is a split elevational top view and side view of the thumb screw for the interlocking protractor hinge in accordance with an embodiment of the present disclosure.

FIG. 14 is a split view of the indexed hinge protractor depicting a perspective view and a cross sectional view in accordance with an embodiment of the present disclosure.

FIG. 15 is a split view of the indexed hinge protractor depicting a top elevational view and a side elevational view in accordance with an embodiment of the present disclosure.

FIG. 16 is a split view of the top slider depicting a perspective view and a side elevational view in accordance with an embodiment of the present disclosure.

FIG. 17 is a split view of the top slider depicting a top elevational view and a side elevational view in accordance with an embodiment of the present disclosure.

FIG. 18 is a split view of the bottom slider for the interlocking protractor hinge depicting a perspective view and a side elevational view in accordance with an embodiment of the present disclosure.

FIG. 19 is a split view of the bottom slider for the interlocking protractor hinge depicting a top elevational view and a longitudinal side elevational view in accordance with an embodiment of the present disclosure.

FIG. 20 is a split view of a straight edge depicting a side elevational view and a top view in accordance with an embodiment of the present disclosure.

FIG. 21 is a top elevational view of a straight edge with an interlocking trough in accordance with an embodiment of the present disclosure.

FIG. 22 is a split view of a straight edge with an interlocking trough depicting a side elevational view and a top elevational view in accordance with an embodiment of the present disclosure.

FIG. 23 is a split view of the indexed protractor dial depicting a perspective view and a side elevational view in accordance with an embodiment of the present disclosure.

FIG. 24 is a top elevational view of the indexed protractor dial in accordance with an embodiment of the present disclosure.

FIG. 25 is a split view of a bossed bottom slider for the interlocking protractor hinge depicting a perspective view and a side elevational view in accordance with an embodiment of the present disclosure.

FIG. 26 is a split view of the bossed bottom slider for the interlocking protractor hinge depicting a top elevational view and a longitudinal side elevational view in accordance with an embodiment of the present disclosure.

FIG. 27 is a split view of a troughed pipe fitting square depicting a perspective view, an elevational side view and a cross sectional view along A-A in accordance with an embodiment of the present disclosure.

FIG. 28 is a split view of a troughed pipe fitting square depicting a perspective view and an elevational side view in accordance with an embodiment of the present disclosure.

FIG. 29 is a depiction of a spring loaded retaining pin for the indexed protractor hinge in accordance with an embodiment of the present disclosure.

Throughout the description, similar and same reference numbers may be used to identify similar and same elements in the several embodiments and drawings. Although specific embodiments of the invention have been illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to a person of ordinary skill in the relevant art and having possession of this disclosure, are to be considered within the scope of the invention.

Throughout the present disclosure, the term “linear force sensitive” refers to the ability of a component of the disclosure to sense the linear force necessary to put the magnetic clip into a locking position relative to the respective square component or both clamped together. Also throughout the present disclosure, the term “adjustable” refers to an adjustable and locking mechanism that allows adjustments to various positions between the magnetic clip and a respective square component via a plurality of linear force sensitive pins. The terms ‘pins,’ and ‘keepers’ and the like are considered synonymous in the present disclosure.

The disclosed pipe fitting device includes at least two pipe fitting members, one or more of which is a straight edge member and one or more of which is a square edge member. An axis is configured to interlock the two members in a variable angular and a variable square configuration. A protractor as disclosed is in axial relation with the interlocking axis and configured to provide an angular measure of the relation of the two members. A system of magnifier lenses is also disposed at the axis and at least one end of the members. Magnets are also received in an outside edge of at least one member for providing a bond between the pipe fitting squaring device and the pipe fittings that aids a user in the squaring process. Additionally, the axis comprises a bottom slider and a top slider configured to slide in a trough of a member and therefore provide a variable axis placement for the joining of the two members. Each member defines an offset trough configured a length thereof to receive a component of the axis including the sliders. The protractor comprises a radial crenellation configured to interlock the members in the angular and square relation. The protractor also defines at least one chamfered hole configured to lock it in place relative to a member.

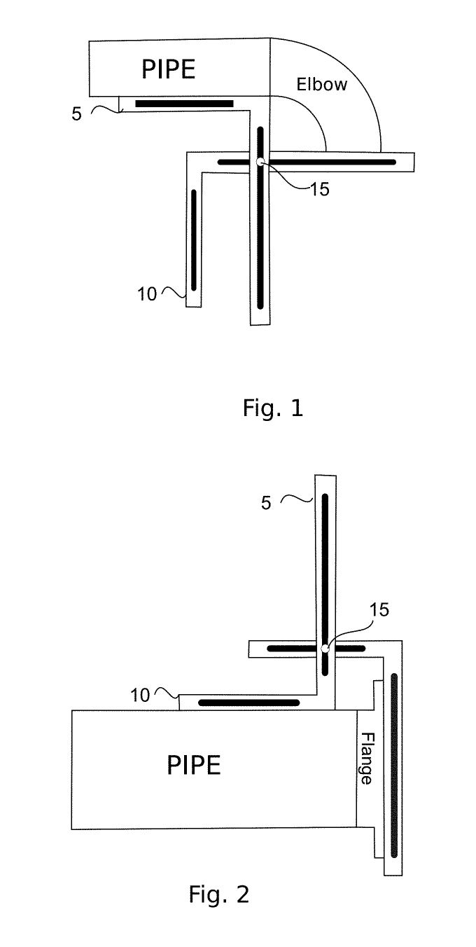

FIG. 1 is a depiction of two interlocking pipe fitting squares configured to square a ninety degree elbow in accordance with an embodiment of the present disclosure. A first member 5 is set on the pipe either magnetically or mechanically and the second member 10 is interlocked with the first member about the axis 15 near a same point of each member by tightening a knob 20 (not shown) at an orthogonal relation indicated by the protractor pair at the axis 15. In the present embodiment, a longer slotted side of one square interrelates to a longer slotted side of the other square but other configurations where a shorter slotted side interrelates to a longer slotted side are subsequently depicted in the present disclosure of which FIG. 2 below is exemplary.

FIG. 2 is a depiction of two interlocking pipe fitting squares configured to square a pipe flange in accordance with an embodiment of the present disclosure. A first member 5 is set on the pipe either magnetically or mechanically and the second member 10 is interlocked with the first member about the axis 15 near a same point of each member by tightening a knob 20 (not shown) at an orthogonal relation indicated by the protractor at the axis 15. In the present embodiment, a longer slotted side of one square interrelates to a shorter slotted side of the other square but other configurations where a slotted side of each member is in an interrelation are also comprehended in the disclosure.

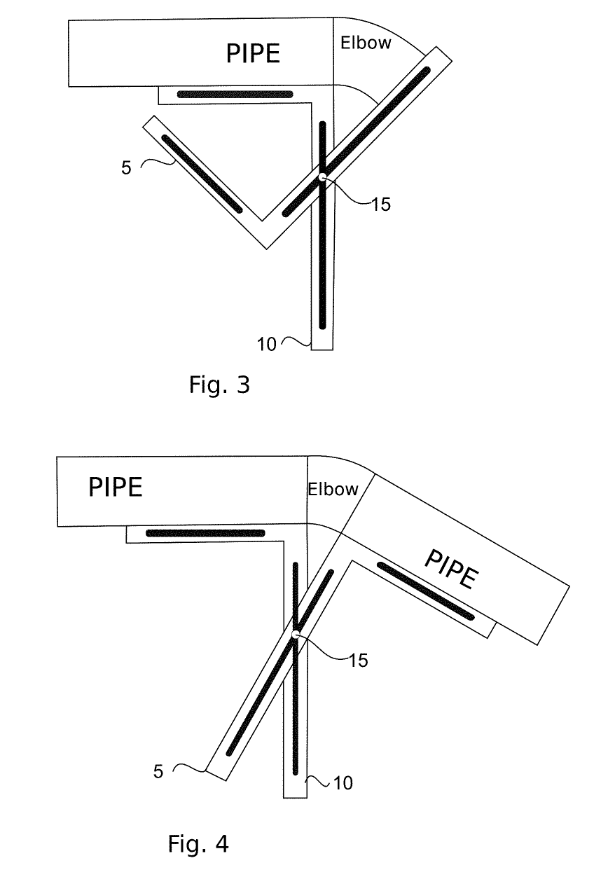

FIG. 3 is a depiction of two interlocking pipe fitting squares configured to square a forty five degree elbow in accordance with an embodiment of the present disclosure. The first member 5 and the second member 10 are configurable to have facing shorter slotted sides as in the present depiction or same direction facing shorter slotted sides as depicted in FIG. 1. A disassembly of the axis 15 allows the interlocking axial pipe fitting squares to be reassembled in any configuration needed to square or align any pipe configuration of straight pipe, flanges, elbows, reducers etc.

FIG. 4 is a depiction of two interlocking pipe fitting squares configured to square a thirty degree elbow in accordance with an embodiment of the present disclosure. A user sets the first member 5 on a first pipe either mechanically or magnetically and sets the protractor portion of the axis 15 to indicate a 30 degree interrelation of the first member to the second member 10. The protractor portion depicted in subsequent drawings may also be set to indicate a 30 degree interrelation or a 45 degree or a 60 degree interrelation etc.

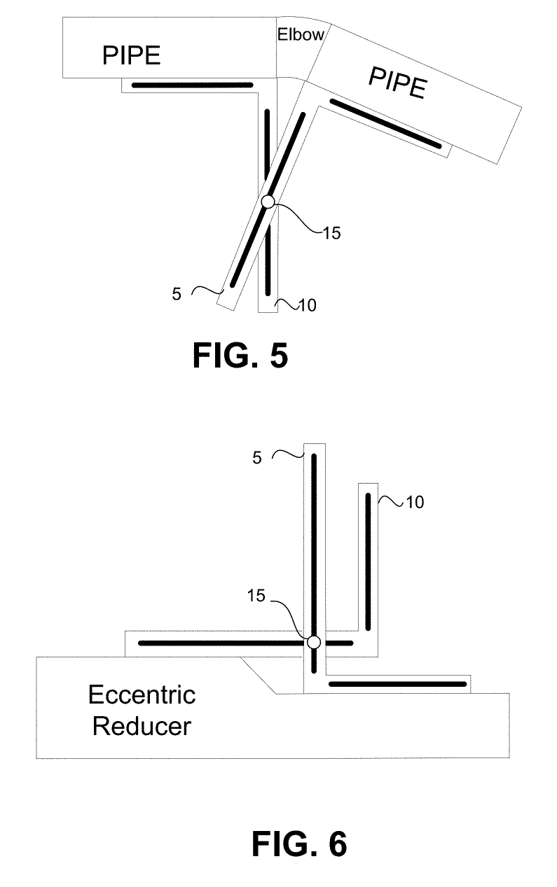

FIG. 5 is a depiction of two interlocking pipe fitting squares configured to square a fifteen degree elbow in accordance with an embodiment of the present disclosure. The protractor portion of the axis 15 indicates a 15 degree interrelation of the first member 5 to the second member 10 to accommodate the 15 degree elbow in this configuration. A 180 degree interrelation may also be set between the two members for a straight extension section of pipe based on a parallel overlay the longer sides of each member 5 and 10. Angles greater than 180 degrees may also be set with the depicted interrelation of the first member 5 to the second member 10 of the pipe fitting squares via the axis 15 and protractor (not depicted).

FIG. 6 is a depiction of two interlocking pipe fitting squares configured to square an eccentric reducer in accordance with an embodiment of the present disclosure. The configuration depicted sets out a longer edge of a first member 5 parallel with a shorter edge of the second member 10 but without any overlay thereof. As defined above, the term square refers to making straight as well as to making orthogonal or perpendicular. Therefore, the protractor may indicate zero degrees or 180 degrees depending on how an operator has set it with respect to the two interlocking members 5 and 10 about the axis 15.

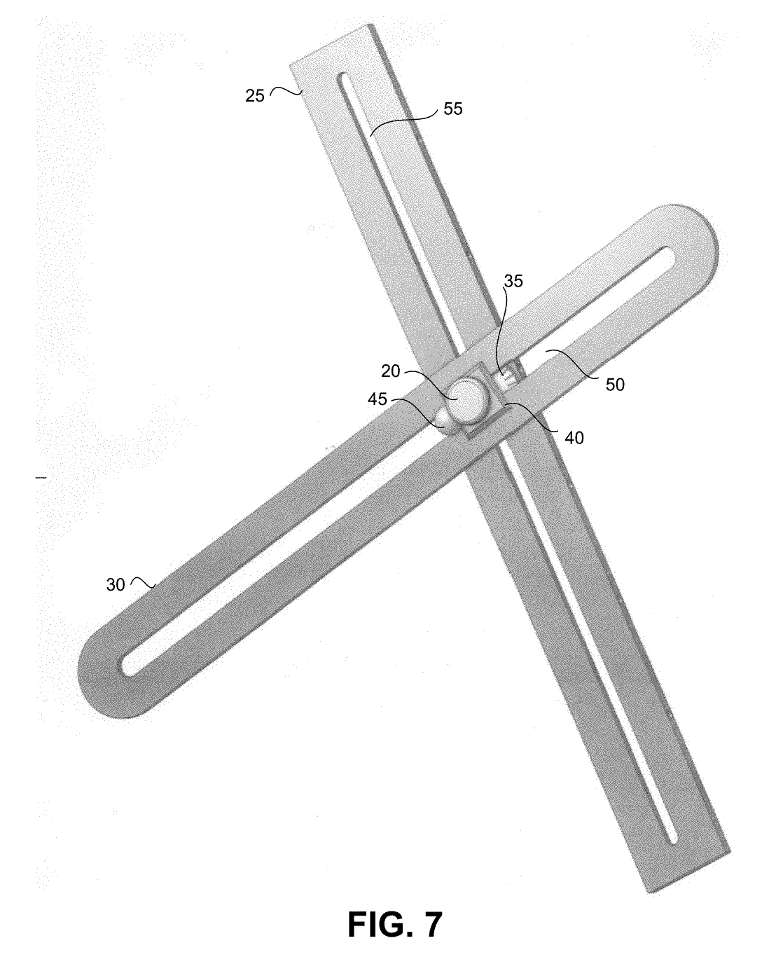

FIG. 7 is a perspective view of interlocking pipe fitting straight edges comprising a protractor hinge in accordance with an embodiment of the present disclosure. The axis for the interlocking pipe fitting straight edges includes a top slider 40 and a bottom slider (not shown), a protractor 35, a thumb screw knob 20 and a magnifying bubble 45. The thumb screw 20 attaches to the bottom slider 25 and the top slider 40 fits in a trough 50 of the top straight edge 30 and slides longitudinally therein. The top slider 40 may have a point for indicating an angle on the protractor 35 indicia. The magnifier 45 may magnify that point on the protractor 35 indicia. The bottom straight edge 25 also has a trough 55 or slot for the bottom slider to move longitudinally therein. The protractor 35 indicates an angular interrelation between the top straight edge 30 and the bottom straight edge 25. Outside edges of the straight edges include magnets receding therein or flush there with for forming a temporary bond between a pipe or a pipe fitting and the interlocking straight edges 25 and 30 in an embodiment. Though only single edges are depicted with receded magnets, multiple inside and outside edges may include the magnets for multiple interlocking straight edge configurations.

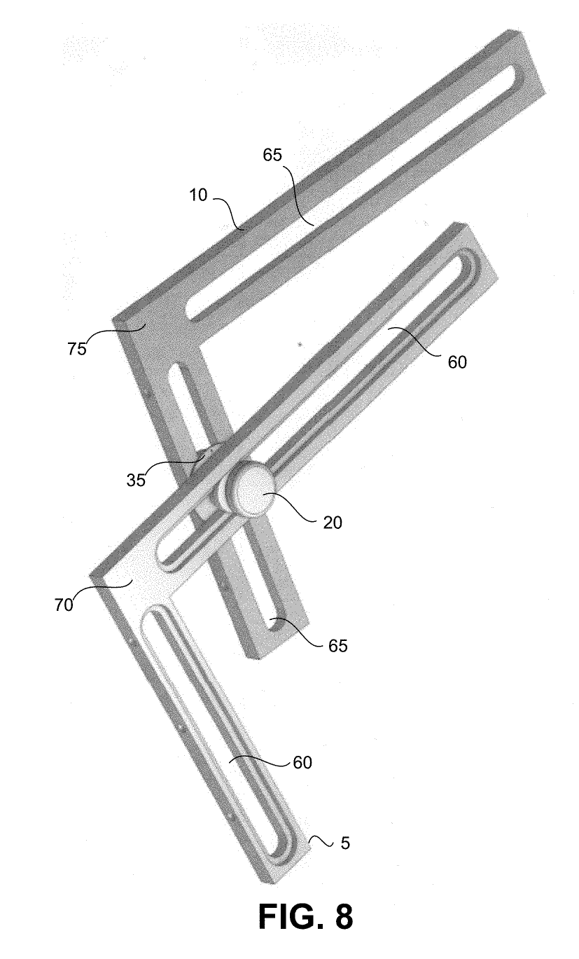

FIG. 8 is a perspective view of interlocking pipe fitting squares comprising a protractor hinge in accordance with an embodiment of the present disclosure. The axis for the interlocking pipe fitting squares includes a top slider 5 and a bottom slider 10, a protractor 35, a thumb screw 20 and a magnifying bubble (not shown). The thumb screw 20 attaches to the bottom slider 10 and the top slider 5 fits in a trough 60 or slot of the top square and slides longitudinally therein. The top slider 5 may have a point for indicating an angle on the protractor 35 indicia. The magnifier may magnify that point (not shown) on the protractor 35 indicia. The bottom square 10 also has a trough 65 or slot for the bottom slider 10 to move longitudinally therein. The protractor 35 indicates an angular interrelation between the top square 5 and the bottom square 10. Outside edges of the squares include magnets receding therein or flush there with for forming a temporary bond between a pipe or a pipe fitting and the interlocking squares in an embodiment. Though only single edges are depicted with receded magnets, multiple inside and outside edges may include the magnets for multiple interlocking square configurations. The top member troughs 60 in each arm may be contiguous through the angle 70 or the troughs may be disparate as depicted. Likewise, the bottom member troughs 65 in each arm may be contiguous through the angle 75 or may be disparate as depicted.

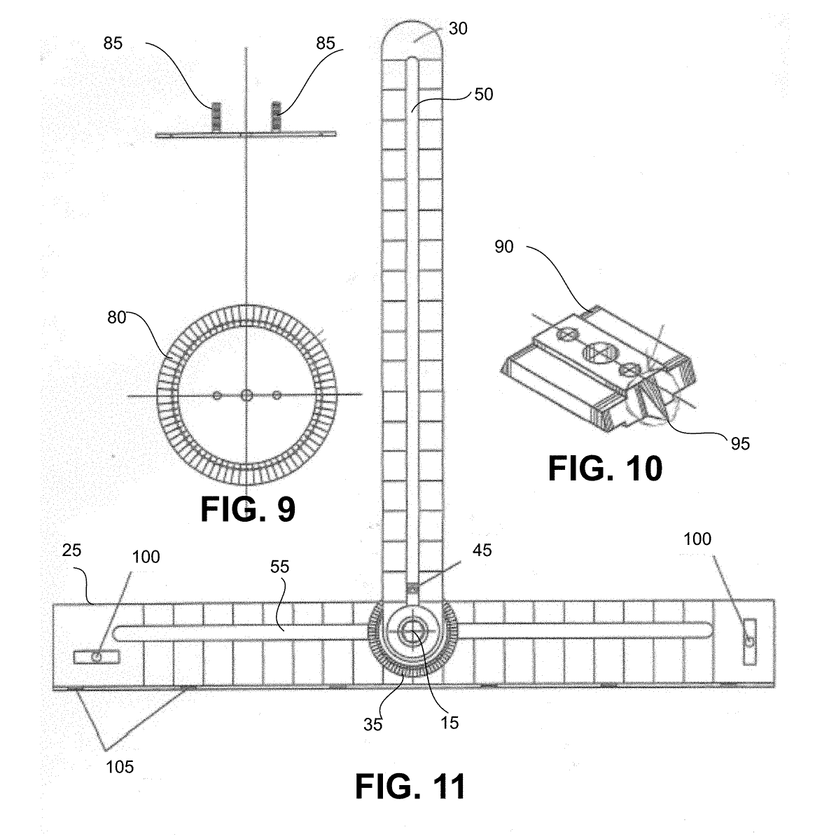

FIG. 9 is a split elevational view and side elevational view of an indexed hinge protractor in accordance with an embodiment of the present disclosure. The protractor 35 comprises an indexed circumference 80 in 10 degree increments and two threaded posts 85 shown in split view for insertion into the top slider of FIG. 10 below to engage with the top slider. The protractor 35 also defines an axial hole for the thumbscrew (not shown) to extend there through into the bottom slider (not shown). Embodiments of the protractor 35 do not include the threaded posts 85 where a communication there between with the top slider is adjustable.

FIG. 10 is a perspective view of a top slider for the interlocking pipe fitting squares in accordance with an embodiment of the present disclosure. The top slider 90 includes an indicating point 95 and an optional magnifier adjacent thereto. The top slider also defines three holes, two for protractor posts and an axial central hole for a thumb screw (not shown) threaded post to be inserted there through. The top slider 90 is depicted square but may also be disc-like and oblong as well.

FIG. 11 is a top view of interlocking pipe fitting straight edges comprising an indexed protractor axis with magnifying lenses in accordance with an embodiment of the present disclosure. A top straight edge 30 and a bottom straight edge 25 comprises longitudinal troughs or slots 50 and 55 respectively therein for one straight edge to slide longitudinally respective to the other straight edge and interlock thereto via the axial components described above including the thumb screw (not shown), the protractor 35, the magnifier 45, the top slider 90 and the bottom slider. Magnifiers 100 are depicted at each end of each straight edge 25 and magnets 105 are depicted in the front outside edge of the bottom straight edge for a temporary bond with a pipe or with a pipe fitting. A length of the top member 30 and a length of the bottom member 25 are indexed in half inch and millimeter increments. The axis 15 of the two members 25 and 30 is adjustable along a length of either and both members.

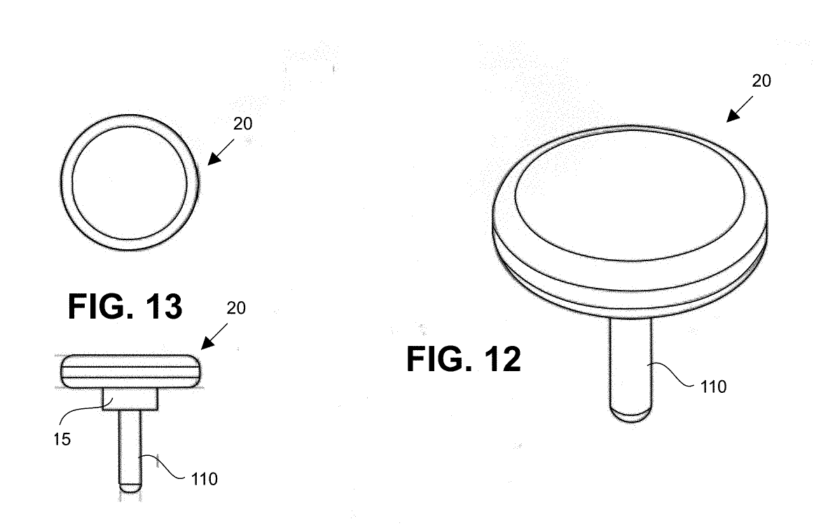

FIG. 12 is a perspective view of a thumb screw for the interlocking protractor hinge in accordance with an embodiment of the present disclosure. The thumb screw 20, includes a knob end used to torque the axial post into the bottom slider (not shown). The axial post 110 may be threaded to be received into a similarly threaded tapped female end of the bottom slider. The knob end is depicted disk like but may also take other shapes which facilitate a manual torque of the axial post.

FIG. 13 is a split elevational top view and side view of the thumb screw for the interlocking protractor hinge in accordance with an embodiment of the present disclosure. Measurements indicated are nominal and may vary according to manufacturing tolerances and design constraints. The view includes the thumbscrew 20 knob and a chamfered top and bottom edge. The view also includes the axial post 110 and a post boss 115 which slides within a member counter trough.

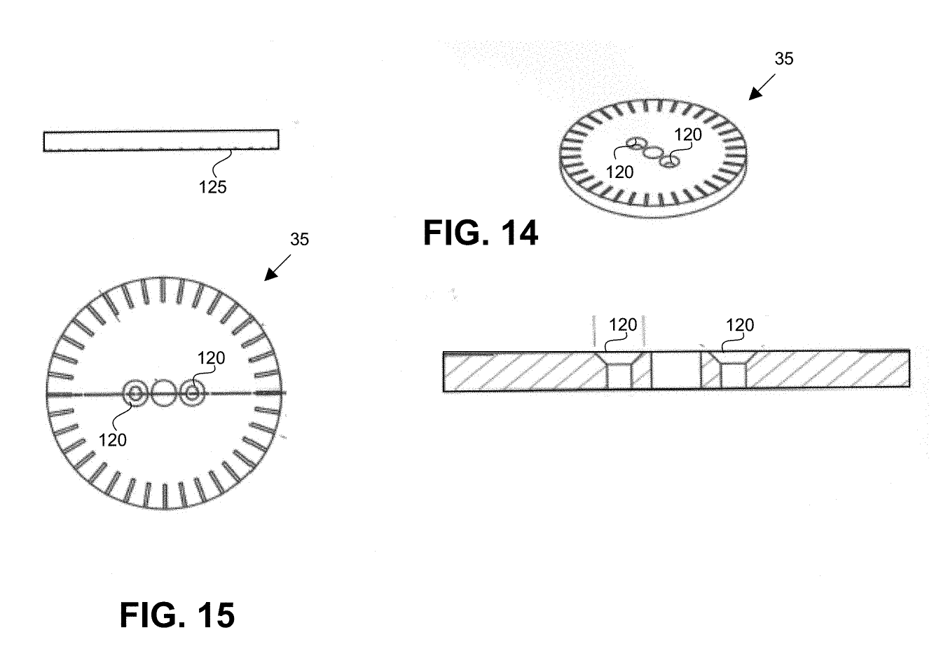

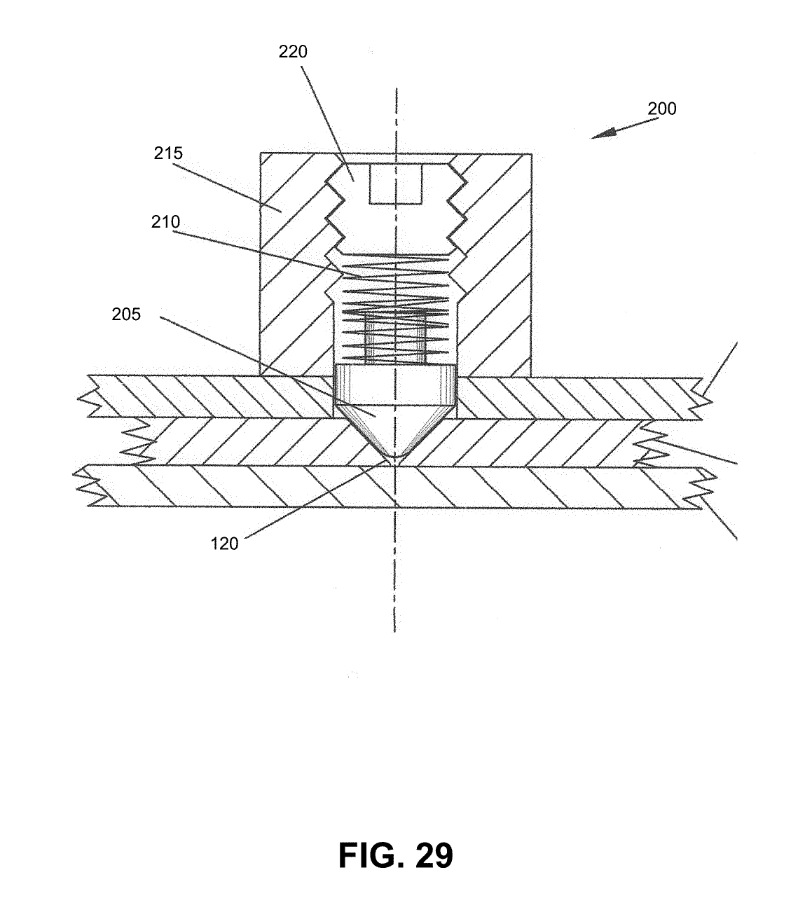

FIG. 14 is a split view of the indexed hinge protractor depicting a perspective view and a cross sectional view in accordance with an embodiment of the present disclosure. The countersunk holes 120 or chamfered holes 120 shown in cross section are configured to receive members from one of the top slider and the bottom slider in order to set the protractor 35 in a fixed relation thereto. The countersunk holes 120 may also receive force sensitive pins depicted in FIG. 29 as explained below for dial adjustable angles. The cross-section A-A of FIG. 14 is taken through the section of A-A in FIG. 15 below.

FIG. 15 is a split view of the indexed hinge protractor depicting a top elevational view and a side elevational view in accordance with an embodiment of the present disclosure. The protractor 35 indicia form a crenelated circumference 125 on the protractor 35 which may interact with a pointed edge of the top slider adjustable thereto. The protractor indicia 125 may be set at 10 degree increments or finer or grosser increments according to model types and intended use for the respective interlocking axial pipe fitting square when manufactured.

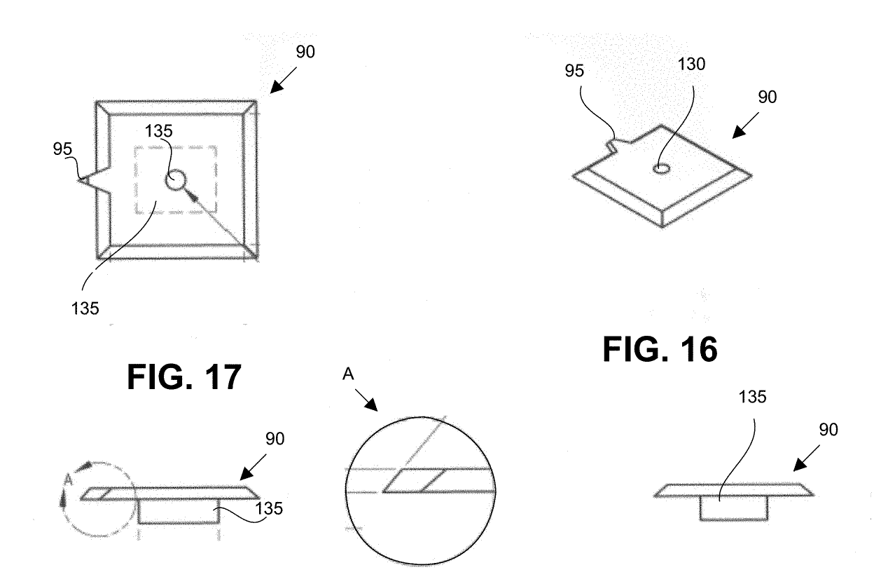

FIG. 16 is a split view of the top slider depicting a perspective view and a side elevational view in accordance with an embodiment of the present disclosure. The top slider 90 depicted includes a pointed 95 side for interacting with the protractor 35 indicia to indicate an interrelation between the straight edge members or the square members. An axial hole 130 is defined therein for insertion of the thumb screw 20 there through into the bottom slider (not depicted). The chamfered top edge is designed to minimize snags and pulls with the operator's clothing or other hindrances. The split view detail depicts an extension of the point 95 from its adjacent side of the top slider 90. The bottom boss extension 135 is configured to slide longitudinally in a trough or slot of a respective straight edge or square member.

FIG. 17 is a split view of the top slider depicting a top elevational view and a side elevational view and a detail view in accordance with an embodiment of the present disclosure. Measurements indicated are nominal and may vary according to manufacturing tolerances and design constraints. The top view of the slider 90 includes an indicating point 95 and an optional magnifier adjacent thereto (not depicted). The slider 90 also defines three holes, two for protractor posts underneath and an axial central thru hole 130 for a thumb screw threaded post 110 to be inserted there through. The top slider 90 view is depicted square but may also be disc-like and oblong as well. The bottom boss extension 135 is indicated underneath with broken lines. The side elevational view of the slider 90 shows the profile of the pointed 95 side encircled in A for the detail view. The detail view of the pointed 95 side illustrates the angle and relative dimensions thereof.

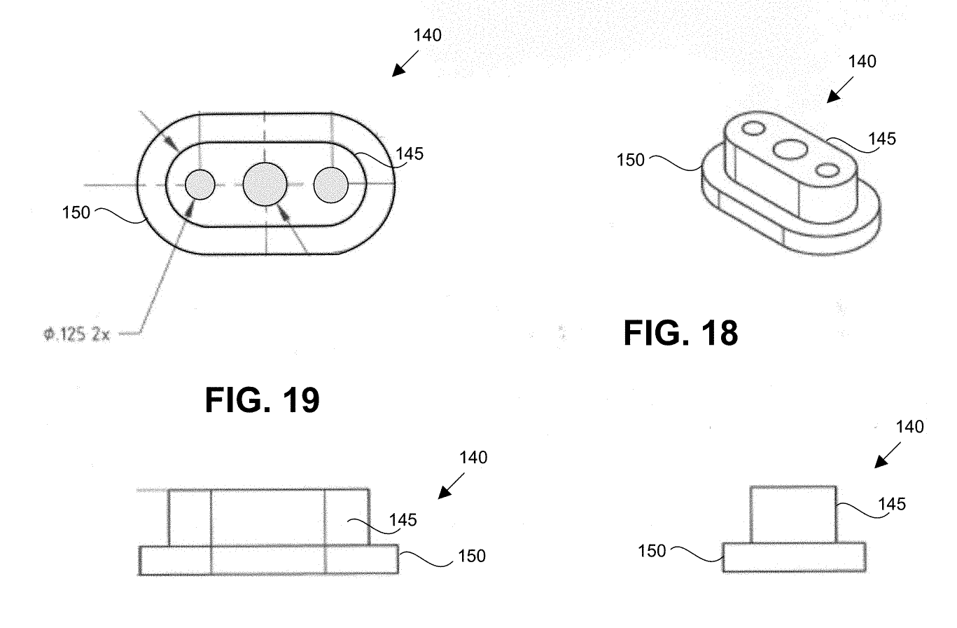

FIG. 18 is a split view of the bottom slider for the interlocking protractor hinge depicting a perspective view and a front side elevational view in accordance with an embodiment of the present disclosure. The bottom slider 140 includes a post or boss 145 which defines 3 holes in the embodiment. The two outlying holes are configured to receive post or bolts from the top slider 90 and the axial center hole is configured to receive the bolt or post 110 of the thumb screw 20. The bottom slider 140 is oblong and longitudinally designed for the boss 145 to slide within a slot or trough of the bottom member of the straight edge or the square pair of members. It therefore has a leading rounded edge and a trailing rounded edge and a bottom plate 150 which overlaps the slot or troughs of the straight and square members.

FIG. 19 is a split view of the bottom slider for the interlocking protractor hinge depicting a top elevational view and a longitudinal side elevational view in accordance with an embodiment of the present disclosure. Measurements indicated are nominal and may vary according to manufacturing tolerances and design constraints. A circular bottom slider (not depicted) design may also be implemented as well as other geometries according to model types, design constraints and intended use of a particular interlocking axial pipe fitting squares.

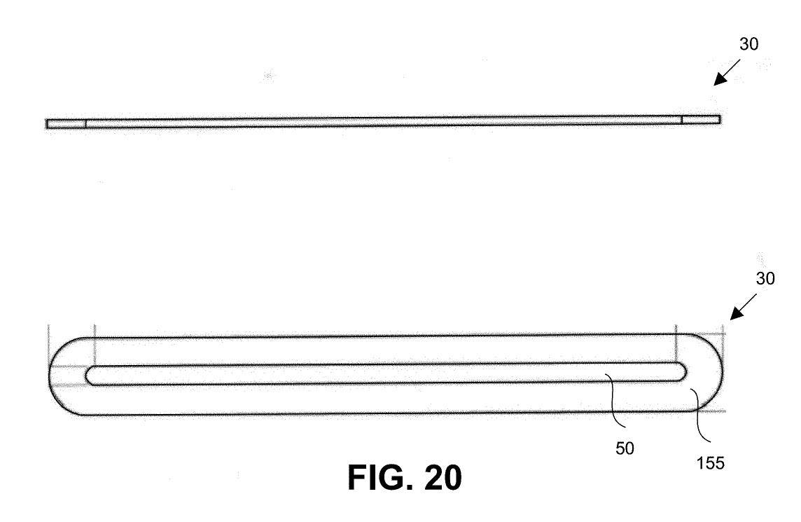

FIG. 20 is a split view of a straight edge depicting a side elevational view and a top view in accordance with an embodiment of the present disclosure. Measurements indicated are nominal and may vary according to manufacturing tolerances and design constraints. The depiction includes the straight edge 30 with a trough or slot 50. An offset or countersunk trough and slot design may also be implemented as well as other trough and slot geometries according to model types, design constraints and intended use of a particular interlocking axial pipe fitting squares. The rounded corners 155 are designed to minimize snags and pulls with the operator's clothing and other hindrances.

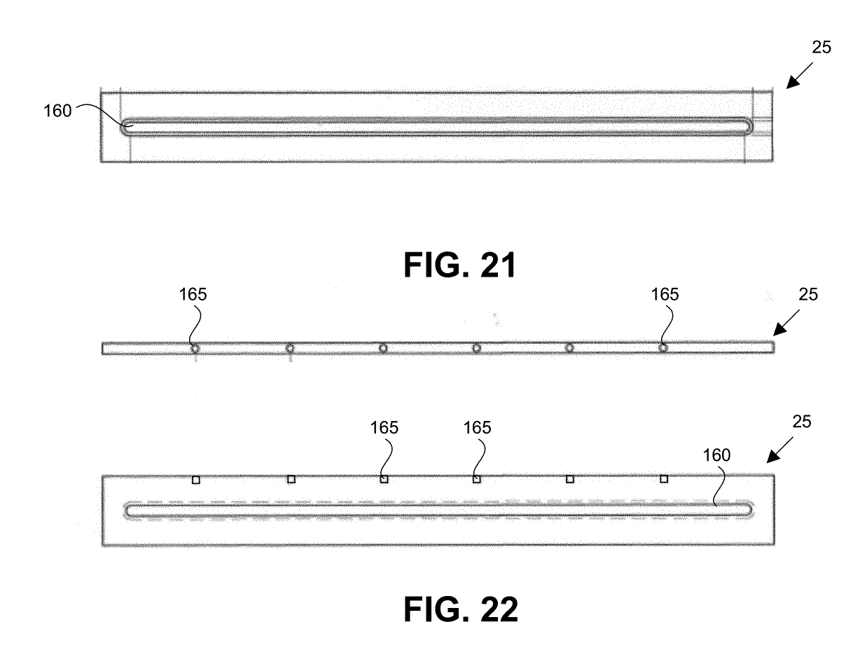

FIG. 21 is a top elevational view of a straight edge with an countersunk trough in accordance with an embodiment of the present disclosure. Measurements indicated are nominal and may vary according to manufacturing tolerances and design constraints. The straight edge member 25 includes an offset or countersunk trough 160 and slot design may also be implemented as well as other trough and slot geometries according to model types, design constraints and intended use of a particular interlocking axial pipe fitting squares. The square corners are designed to provide orthogonal edges for further squaring of pipe fitting configurations.

FIG. 22 is a split view of a straight edge with an interlocking trough depicting a side elevational view and a top elevational view in accordance with an embodiment of the present disclosure. Similarities with the depiction of FIG. 21 are referenced by same reference numbers. The broken line depicts the countersunk edge for a bottom slider 140 or a top slider 90 (not depicted). The countersunk holes 165 periodically place in an edge of the straight edge member 25 are configured to receive magnets to temporarily bond the respective edge to a pipe or to a pipe fitting during use of the interlocking axial pipe fitting straight edge 25.

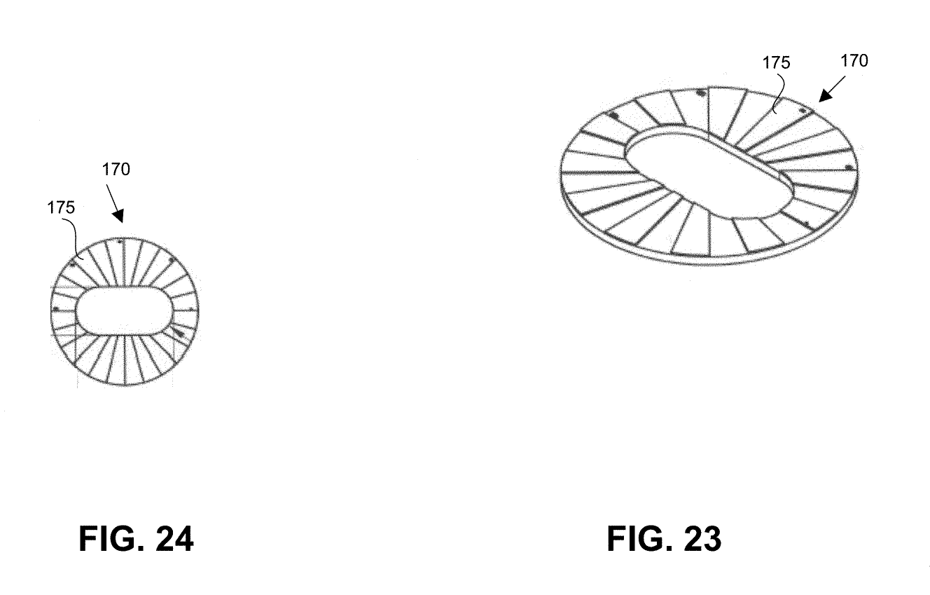

FIG. 23 is a split view of the crenelated protractor dial depicting a perspective view in accordance with an embodiment of the present disclosure. The depicted protractor 170 or dial of the embodiment comprises a radially crenelated top surface 175 configured to interlock with another protractor that is indexed or a top slider 90 to ratchet an angular interrelation of one straight edge or square member with another straight edge or square member.

FIG. 24 is a top elevational view of the crenelated collar in accordance with an embodiment of the present disclosure. Measurements indicated are nominal and may vary according to manufacturing tolerances and design constraints. The depicted collar 170 defines a cavity complementary with the boss 145 of the bottom slider 140 and therefore sits on the shelf 150 of the bottom slider boss 145 and the bottom portion thereof like a collar. A complementary radially crenelated underside of an indexed protractor will lock into place with the crenelated protractor fixed in place on the bottom slider 140. A slight torque force will dislodge the indexed protractor from the crenelated collar to a subsequent crenellation on the collar. The interface of the bottom side of the indexed protractor and the upper side of the crenelated collar may be lubricated to induce slippage or a spring loaded interface may be provided to lessen the torque requirement for a transition.

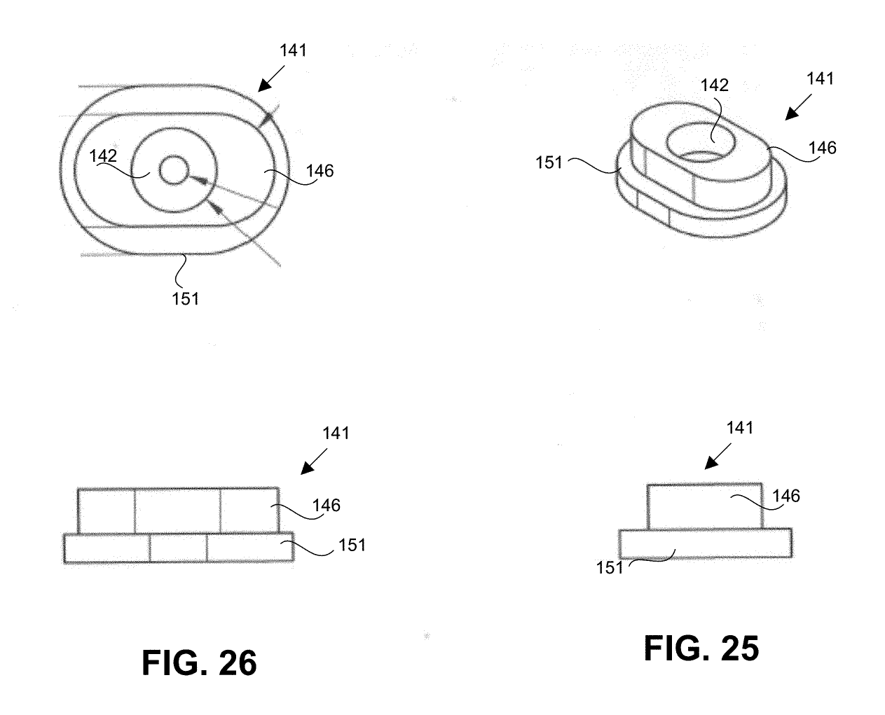

FIG. 25 is a split view of a bossed bottom slider for the interlocking protractor hinge depicting a perspective view and a side elevational view in accordance with an embodiment of the present disclosure. The post or boss of this bottom slider facilitates mating with the top slider 90 or thumb screw 20 by fitting into a countersunk trough or slot in the respective straight edge or square member. The larger hole 142 in the boss 146 facilitates a post implementation from an embodiment of the top slider (not depicted) and protractor.

FIG. 26 is a split view of the bossed bottom slider for the interlocking protractor hinge depicting a top elevational view and a longitudinal side elevational view in accordance with an embodiment of the present disclosure. Measurements indicated are nominal and may vary according to manufacturing tolerances and design constraints.

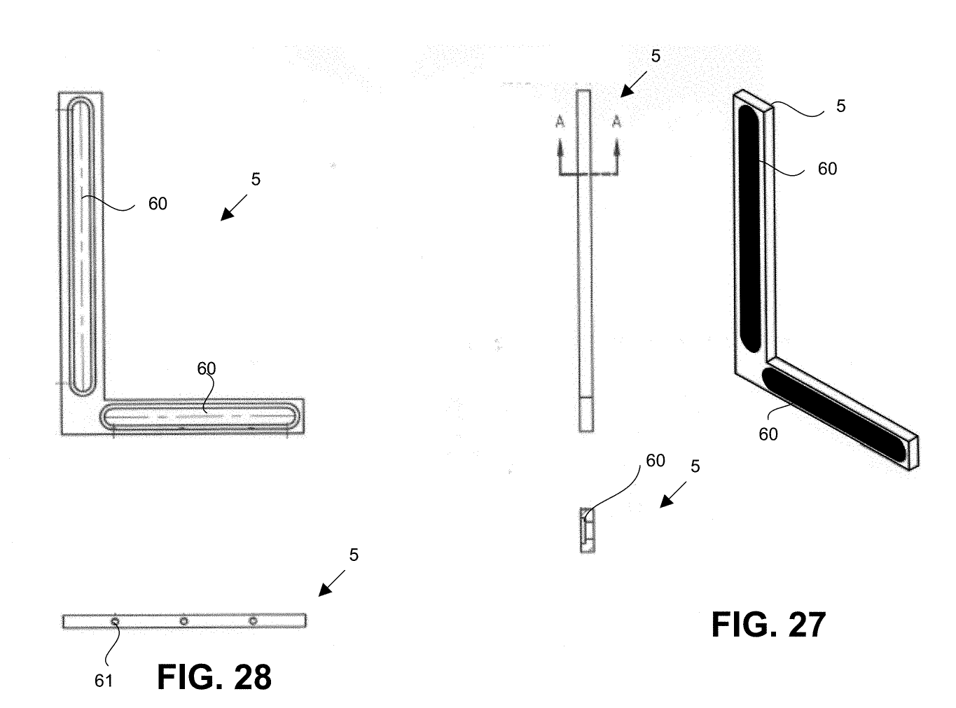

FIG. 27 is a split view of a troughed pipe fitting square depicting a perspective view, an elevational side view and a cross sectional view along A-A in accordance with an embodiment of the present disclosure. Measurements indicated are nominal and may vary according to manufacturing tolerances and design constraints. The square member 5 includes an offset or countersunk trough 60 and slot design may also be implemented as well as other trough and slot geometries according to model types, design constraints and intended use of a particular interlocking axial pipe fitting squares. The square corners are designed to provide orthogonal edges for further squaring of pipe fitting configurations.

FIG. 28 is a split view of a troughed pipe fitting square including edge embedded magnets depicts a perspective view and an elevational side view in accordance with an embodiment of the present disclosure. Measurements indicated are nominal and may vary according to manufacturing tolerances and design constraints. The embodiment includes the square member 5 and the countersunk trough 60 and slot design. The magnets 61 are embedded in an edge of the square member 5.

FIG. 29 is a depiction of a spring loaded retaining pin for the indexed protractor hinge in accordance with an embodiment of the present disclosure. The embodiment includes linear force sensitive keepers 200 having pins 205 with a static frictional load against chamfered holes 120 of the respective square component (see FIG. 14) for receiving the pin. A spring 210 is adjusted to a spring tension equal to a linear force necessary to slide a collar along an edge of the protractor 35 or a respective square component. A body 215 for retaining the pin 200 is included in embodiments of the disclosure where a helical adjustment of the spring tension is facilitated through a helical recess and a helical screw 220 fitted therein.

The static frictional load is less than a torque applied to the collar position relative to the square component. Additionally, or in the alternative, the linear force sensitive keepers 200 comprise a spring loaded pin 205 having a spring load less than a linear force applied to the collar relative to the respective square device to urge a pin out from a locked position in the chamfered recess or hole 120 thereof.

The chamfered holes 120 are configured to receive a conical shaped pin in a semi-temporary locking relation against movement in the same plane. The pins 205, keepers or protrusions are configured to lock with the chamfered holes 120 of the square component and retract therefrom based on a force applied by a user thereon.

Embodiments are included wherein the plurality of linear sensitive pins and supporting structures thereof including various embodiments where the chamfered recesses or holes 120 are defined equidistantly along a flange of a square device or along a flat stock edge thereof. However, as few as one and any number of pins and corresponding chamfered holes or adjustable keepers are also included in an embodiment of the present disclosure.

In an additional embodiment of the disclosure, the linear force necessary to move a keeper 205, protrusion, pin or bump from a chamfered hole 120 of the respective square component comprises a nominal 10 ft-lbs to 15 ft-lbs force. This linear force is usually provided by the operator or user in order to adjust the collar to a position relative to the square that provides him or her, the best pipe fit at a crest of the pipe. The force necessary to dial in or adjust the collar into a locked position may be based on a helical adjustment of the pin 205 penetration relative to a chamfered hole 120 in the respective square component. The helical adjustment may be via an adjusting plug 220 or screw which puts pressure directly or indirectly on a pin spring 210. Additionally, the helical adjustment of a spring 210 coil length acting on the pin 205 relative to a chamfered hole 120 varies the linear force on the square component in a sliding adjustment.

Disclosed in another embodiment of the present disclosure, the linear force sensitive pins referred comprise a spring loaded cone or pin having a spring load less than a force applied to the collar. Yet still, the force sensitive pins 205 comprise a spring loaded ball bearing having a spring load less than a torque applied to the collar relative to the square component to change a locked position thereto.

The linear force is sufficient to urge the cone pin 205 to retract from the chamfered hole 120. The torque sensitive spring 210 supplies enough counter force to the movement of the cone pin 205 to offset the retracting motion and allow the cone pin 205 to lock into subsequent index chamfered hole 120 based on the operator. Therefore, the static friction between the cone pin 205 and the chamfered hole 120 is overcome by the linear force applied thereto but is subsequently itself overcome by the spring force or spring constant of the torque sensitive spring 210. This interplay of forces allows a new locking formation in a subsequent chamfered hole 120 chosen by the operator applying the sliding linear force.

The spring force enables a dialing and locking motion to occur over and over again. However, the spring constant of the torque sensitive spring 210 is not greater than the force resulting in retracting the cone pin 205 from the chamfered hole 120. A ball bearing implementation may draw spring force from a torque sensitive spring 210 between the ball bearing in the chamfered hole 120 and the helical plug 220.

The non-obvious and novel features and advantages of the present disclosure are not limited to the applications disclosed herein. Other pipe fitting applications requiring more complex piping and squaring configurations are implicitly included. The rotatable and adjustable pipe fitting square disclosed magnetically adheres to a crest of the pipes to be fitted and therefore provides the most accurate measurements to the pipe fitter. Magnets of varying strengths also allow the disclosure to sit atop a section of pipe unsupported by a user's hands etc so the pipe fitter is able to weld without removing the disclosed square device.

A level indicator such as a dual convex magnified rotatable level indicator may be lit electronically or via luminescence. A single convex magnified implementation is also included in embodiments. A first end is flanged while a second end is a flat stock end and un-flanged. However, the second end may be fitted with the magnetic clip to comprise a flanged end as further disclosed and depicted herein. Supporting magnifying and illuminating indicia or devices are also included in this embodiment. Magnifying lens may be either a bubble type or a flat type depending on cost and manufacturing constraints.

A dual convex magnifying lens may be included but also a non-convex magnifying lens may be used to such as a Frenel lens. Single convex magnifying lenses may also be included in embodiments. Any of the indicators may be lit electronically (embedded light emitting diode LED) or via luminescence. Electronic leveling components may also be included in the rotatable level indicator replacing or augmenting the bubble level vial. The rotatable level indicator includes a bubble level centrally inserted in a spherical magnifying lens. Also, the lighting via an LED component embedded therein or inserted through an opening in a body of the lens is included in embodiments.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Notwithstanding specific embodiments of the invention have been described and illustrated, the invention is not to be limited to the specific forms or arrangements of parts so described and illustrated. The scope of the invention is to be defined by the claims and their equivalents included herein or by reference to a related application.

What is claimed is:

1. A pipe fitting squaring device, comprising:
two pipe fitting members comprising one or more of a straight edge member and one or more of a square edge member, wherein each member comprises lengthwise troughs;
an axis configured to interlock the two members in a variable angular and a variable square configuration at any point in the troughs; and
a protractor in axial relation with the interlocking axis and configured to interlock with at least one member to provide an angular measure of the relation of the two members.

2. The squaring device of claim 1, further comprising a plurality of magnifier lenses disposed at the axis and at least one end of the members.

3. The squaring device of claim 1, further comprising a plurality of magnets received in an outside edge of a member.

4. The squaring device of claim 1, wherein the axis comprises a bottom slider and a top slider configured to slide in a trough of a member.

5. The squaring device of claim 1, wherein the protractor comprises a radial crenellation configured to interlock the members in an angular and square relation.

6. The squaring device of claim 1, wherein the protractor defines at least one chamfered hole configured to lock it in place relative to a member.

7. The squaring device of claim 1, wherein each member defines an offset trough configured in a length thereof to receive a component of the axis.

8. The squaring device of claim 1, further comprising at least one level indicia set within a member, the indicia configured to include a built in magnifying lens for a user thereof.

9. The squaring device of claim 1, further comprising a magnetic clip adjustable to fit an outside edge of a member and comprising a plurality of linear force sensitive and adjustable pins adapted to engage therewith.

10. The squaring device of claim 1, further comprising at least one angularly adjustable level indicator in each of the components aligned in a same plane as one flat stock edge of the component.

11. The squaring device of claim 1, further comprising at least one fixed level indicator in each of the components, the fixed level indicator aligned one of orthogonally and parallel to a straight edge of the respective component.

12. The squaring device of claim 1, further comprising at least one level indicia set within each of the components, an area of the indicia configured to emit light via an active light and a luminescence.

13. A pipe fitting squaring device, comprising:
two pipe fitting members comprising one or more of a straight edge member and one or more of a square edge member, wherein each member comprises lengthwise troughs;
an axis configured to interlock the two members in a variable angular and a variable square configuration at any point in the troughs;
an indexed protractor in axial relation with the interlocking axis and configured to provide an angular measure of the relation of the two members; and
a plurality of torque sensitive conical protrusions configured to lock with a chamfered hole of the indexed protractor and retract therefrom based a torque on the indexed protractor relative to the two pipe fitting members.

14. The pipe fitting square device of claim 13, wherein the torque sensitive conical protrusions comprise a static frictional load against the chamfered holes of the indexed protractor less than a torque applied to the two pipe fitting members to change a locked position of the indexed protractor relative to the two pipe fitting members.

15. The pipe fitting square device of claim 13, wherein the torque sensitive keepers comprise a spring loaded pin having a spring adjustable resisting force less than a torque force applied to the indexed protractor relative to the two pipe fitting members to urge a pin out from a locked position in the chamfered hole of the indexed protractor.

16. A method for squaring a pipe fitting, the method comprising:
configuring two pipe fitting members comprising one or more of a straight edge member and one or more of a square edge member, wherein each member comprises lengthwise troughs, via
an axis configured to interlock the two members in a variable angular and a variable square configuration at any point in the troughs;
indexing a protractor in axial relation with the interlocking axis and configured to interlock with at least one member to provide an angular measure of the relation of the two members; and
disposing a plurality of torque sensitive conical protrusions to lock with a chamfered hole of the indexed protractor and retract therefrom based a torque on the indexed protractor relative to the two pipe fitting members.

17. The squaring device of claim 16, further comprising a plurality of magnifier lenses disposed at the axis and at least one end of the members.

18. The squaring device of claim 16, further comprising a plurality of magnets received in an outside edge of a member.

19. The squaring device of claim 16, wherein the axis comprises a bottom slider and a top slider configured to slide in a trough of a member.

20. The squaring device of claim 16, wherein the protractor comprises a radial crenellation configured to interlock the members in an angular and square relation.
